(19) United States
(12) Patent Application Publication
(10) Pub. No.: US 2005/0211390 A1
(43) Pub. Date: Sep. 29, 2005

(54) Shading device for automobile

(75) Inventor: Paul Lin, Yung-Kang City (TW)

Correspondence Address: LOWE HAUPTMAN GILMAN & BERNER LLP, Suite 310, 1700 Diagonal Road, Alexandria, VA, 22314, US

(73) Assignee: MACAUTO INDUSTRIAL CO., LTD.

(21) Appl. No.: 10/849,959

(22) Filed: May 21, 2004

(30) Foreign Application Priority Data
Mar. 26, 2004 (TW) 93204672

(51) Int. Cl. E06B 9/08

(52) U.S. Cl. 160/23.1; 160/273.1

(57) ABSTRACT

A shading device includes a flexible sheet, a winding member, and slide rails. The flexible sheet has a first end, a second end, and two opposite sides. The winding member includes a spring roller connected to the first end and operable to wind and unwind the flexible sheet. The slide rails extend along and are disposed adjacent to the opposite sides of the flexible sheet, respectively. The slide rails respectively have slide channels and constricted slits. Each of the opposite sides of the flexible sheet has sliding elements which have enlarged portions projecting into a corresponding one of the slide channels for sliding therealong, and neck portions connecting respectively the enlarged portions to the corresponding one of the opposite sides and passing through one of the constricted slits. Some of the sliding elements interpose other ones of the sliding elements when the flexible sheet is wound.

### BACKGROUND OF THE INVENTION

1. Field of the Invention

The invention relates to a shading device, more particularly to a shading device for an automobile.

2. Description of the Related Art

There are a variety of conventional shading devices for automobiles available in the market. Most of the conventional shading devices include a flexible sheet and a winding member for winding and unwinding the flexile sheet. Some of the conventional shading devices further include a pair of slide rails for guiding sliding movement of a pull bar that is mounted on the flexible sheet opposite to the winding member so as to extend the flexible sheet.

Two sides of the flexible sheet proximate to the slide rails are usually cut when making the flexible sheet, which results in the formation of corrugated edges at the sides of the flexible sheet that can prevent the flexible sheet from being extended evenly. A conventional solution to this problem is to fold and sew the sides of the flexible sheet. However, this will double the thickness at the sides of the flexible sheet. Therefore, the size of the winding member is required to be increased for receiving the wound flexible sheet. Furthermore, the flexible sheet is liable to sag due to the uneven thickness thereof.

### SUMMARY OF THE INVENTION

The object of the present invention is to provide a shading device for an automobile that is capable of being extended evenly.

Accordingly, the shading device of this invention includes a flexible sheet, a winding member, and a pair of opposite slide rails. The flexible sheet has a first end, a second end, and two opposite sides interconnecting the first and second ends. The winding member includes a spring roller connected to the first end of the flexible sheet and operable so as to wind and unwind the flexible sheet. The opposite slide rails extend along and are disposed adjacent to the opposite sides of the flexible sheet, respectively. The slide rails respectively have slide channels and constricted slits. Each of the opposite sides of the flexible sheet has a plurality of sliding elements which have enlarged portions projecting into a corresponding one of the slide channels for sliding therealong when winding and unwinding the flexible sheet, and neck portions connecting respectively the enlarged portions to the corresponding one of the opposite sides and passing through one of the constricted slits. Some of the sliding elements interpose other ones of the sliding elements when the flexible sheet is wound on the spring roller.

### BRIEF DESCRIPTION OF THE DRAWINGS

Other features and advantages of the present invention will become apparent in the following detailed description of the preferred embodiment with reference to the accompanying drawings, of which:

FIG. 1 is a partly sectional perspective view of the preferred embodiment of a shading device for an automobile according to this invention;

FIG. 2 is a fragmentary perspective view of a flexible sheet of the preferred embodiment;

FIG. 3 is a partly sectional perspective view of the preferred embodiment in a wound state;

FIG. 4 is a fragmentary sectional view of the preferred embodiment taken along line IV-IV in FIG. 1; and

FIG. 5 is a fragmentary sectional view of the preferred embodiment taken along line V-V in FIG. 1.

### DETAILED DESCRIPTION OF THE PREFERRED EMBODIMENT

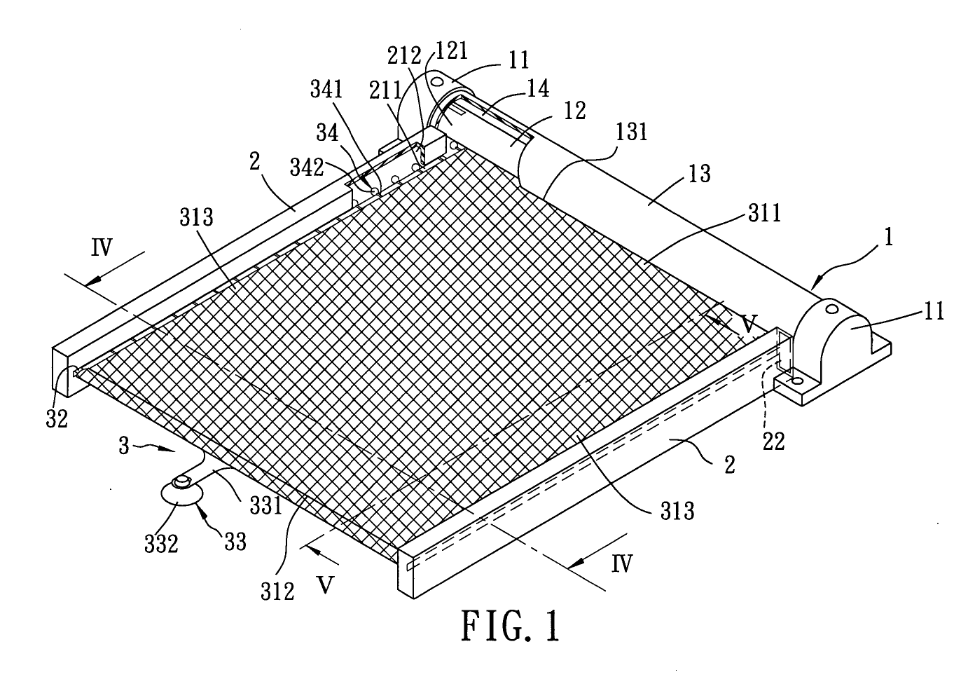

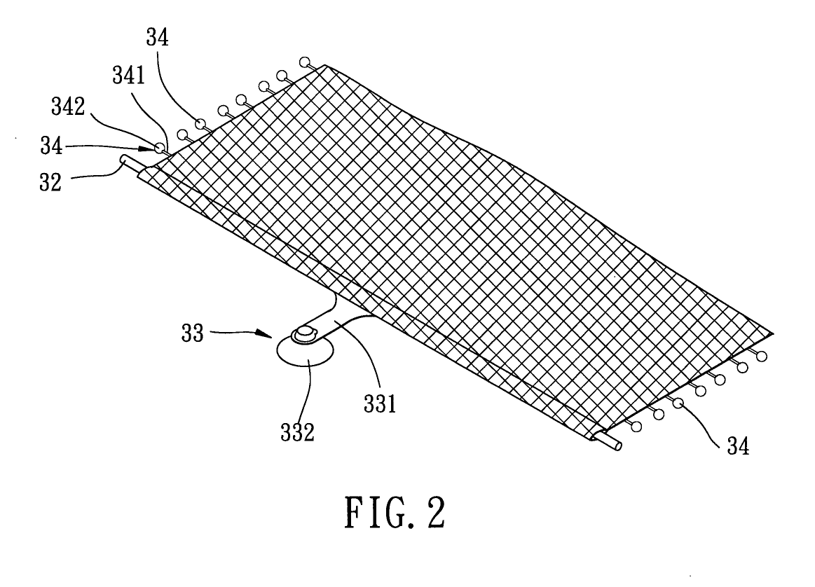

Referring to FIGS. 1 and 2, the preferred embodiment of a shading device according to this invention is shown to be used for shading an automobile from sunlight. The shading device can be mounted on a front windshield, a sunroof, door windows, or a rear windshield.

The shading device includes a flexible sheet 3, a winding member 1, and a pair of opposite slide rails 2. The flexible sheet 3 has a first end 311, a second end 312, and two opposite sides 313 interconnecting the first and second ends 311, 312. The flexible sheet 3 is provided with a pull bar 32 and a positioning member 33 at the second end 312 thereof. The positioning member 33 has a flexible elongate portion 331 extending from the second end 312 of the flexible sheet 3, and a positioning unit 332 connected to the flexible elongate portion 331 opposite to the pull bar 32.

The winding member 1 includes a pair of seat members 11, a spring roller 12, and a housing 13. The seat members 11 are spaced apart from each other. The spring roller 12 extends between the seat members 11, and has opposite end portions 121 mounted rotatably and respectively on the seat members 11. The spring roller 12 is connected to the first end 311 of the flexible sheet 3, and is operable so as to wind and unwind the flexible sheet 3. The housing 13 covers the spring roller 12, and is connected to the slide rails 2. The housing 13 has an elongate slit 131 extending between the seat members 11 to permit passage of the flexible sheet 3 therethrough, and defines a receiving space 14 between the housing 13 and the spring roller 12.

The opposite slide rails 2 extend along and are disposed adjacent to the opposite sides 313 of the flexible sheet 3, respectively. The slide rails 2 respectively have slide channels 212 and constricted slits 211. The slide rails 2 further have respective openings 22, which communicate with the housing 13 and which further communicate respectively with the slide channels 212.

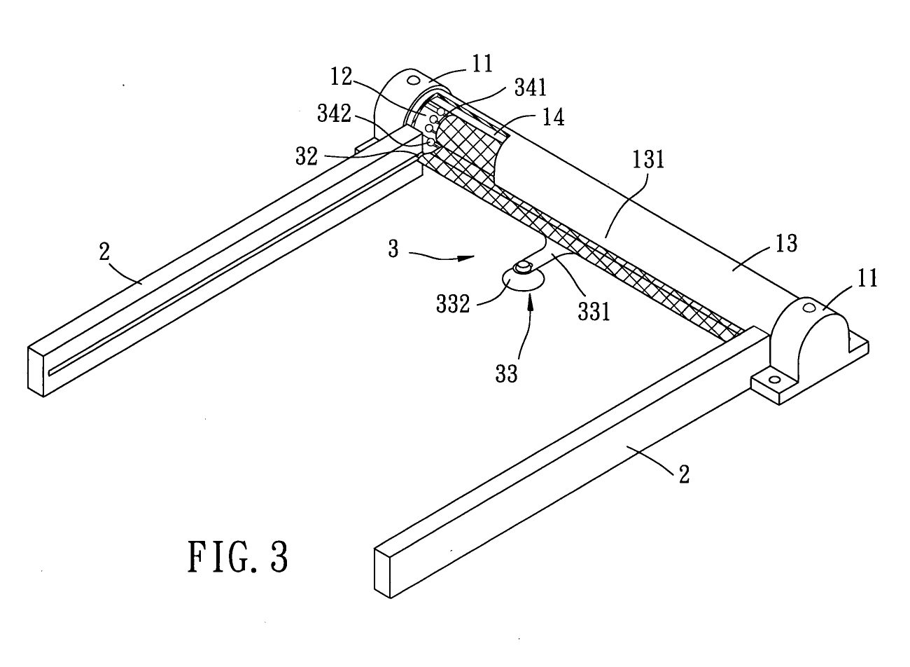

Each of the opposite sides 313 of the flexible sheet 3 has a plurality of sliding elements 34 which have enlarged portions 342 projecting from a corresponding one of the opposite sides 313 of the flexible sheet 3 into a corresponding one of the slide channels 212 for sliding therealong when winding and unwinding the flexible sheet 3, and neck portions 341 connecting respectively the enlarged portions 342 to the corresponding one of the opposite sides 313 and passing through one of the constricted slits 211. Referring to FIG. 3, some of the sliding elements 34 interpose other ones of the sliding elements 34 when the flexible sheet 3 is in a wound state in which the flexible sheet 3 is wound on the spring roller 12. Preferably, the neck portion 341 of each of the sliding elements 34 is flexible, and has a rod-like shape. The enlarged portion 342 of each of the sliding elements 34 is rigid, and has a ball-like shape.

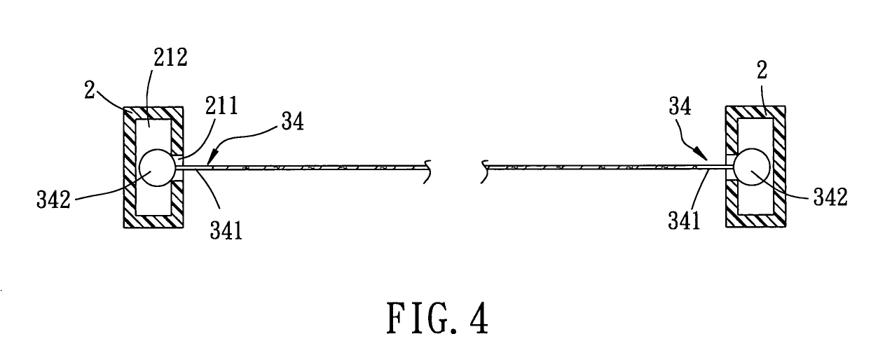

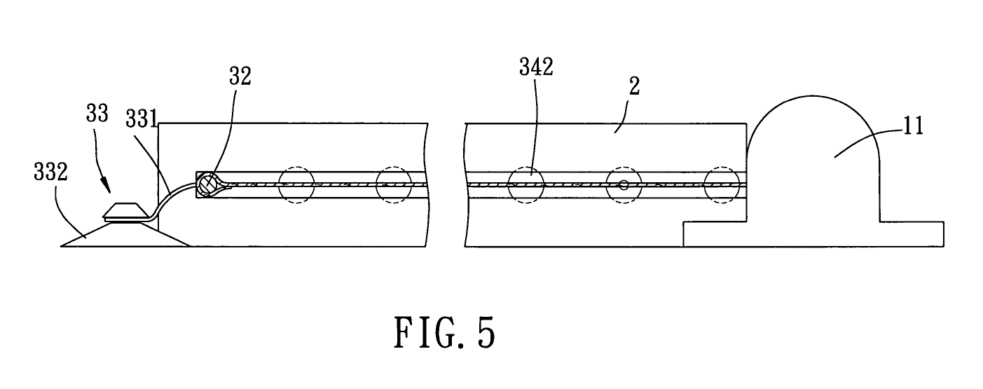

Referring to FIGS. 1, 4 and 5, when the pull bar 32 is pulled away from the winding member 1 along the constricted slits 211 of the slide rails 2, the flexible sheet 3 is pulled out of the receiving space 14 through the elongate slit 131 of the housing 13, and is extended away from the winding member 1. The enlarged portions 342 of the sliding elements 34 are slid along the slide channels 212 of the slide rails 2 via the openings 22. Since the size of the enlarged portion 342 of each sliding element 34 is larger than the slit width of the constricted slit 211 of each slide rail 2, the enlarged portions 342 of the sliding elements 34 are confined within the slide channels 212 of the slide rails 2.

When the flexible sheet 3 is extended to a desired position, the desired position of the flexible sheet 3 can be maintained by fixing the positioning unit 332 of the positioning member 33 on the window of the automobile. The extended flexible sheet 3 can be stretched evenly by the sliding elements 34. When the extended flexible sheet 3 is intended to be wound back within the receiving space 14 of the winding member 1, the positioning unit 332 of the positioning member 33 is removed from the window of the automobile. Then, the flexible sheet 3 can be drawn back to the winding member 1 by the spring roller 12.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A shading device for an automobile, comprising:
a flexible sheet having a first end, a second end, and two opposite sides interconnecting said first and second ends;
a winding member including a spring roller connected to said first end of said flexible sheet and operable so as to wind and unwind said flexible sheet; and a pair of opposite slide rails extending along and disposed adjacent to said opposite sides of said flexible sheet, respectively, said slide rails respectively having slide channels and constricted slits,
each of said opposite sides of said flexible sheet having a plurality of sliding elements which have enlarged portions projecting into a corresponding one of said slide channels for sliding therealong when winding and unwinding said flexible sheet, and neck portions connecting respectively said enlarged portions to the corresponding one of said opposite sides and passing through one of said constricted slits,
wherein some of said sliding elements interpose other ones of said sliding elements when said flexible sheet is wound on said spring roller.

2. The shading device as claimed in claim 1, wherein said winding member further includes a housing covering said spring roller and connected to said slide rails, said slide rails further having respective openings which communicate with said housing and which further communicate respectively with said slide channels.

3. The shading device as claimed in claim 1, wherein said neck portion of each of said sliding elements is flexible, and said enlarged portion of each of said sliding elements is rigid.

4. The shading device as claimed in claim 3, wherein said neck portion of each of said sliding elements has a rod-like shape, and said enlarged portion of each of said sliding elements has a ball-like shape.
